(19) United States
(12) Patent Application Publication
(10) Pub. No.: US 2006/0022990 A1
(43) Pub. Date: Feb. 2, 2006

(54) Generating subdivision surfaces on a graphics hardware with floating-point fragment shaders

(75) Inventor: Radomir Mech, Mountain View, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Silicon Graphics, Inc., Mountain View, CA (US)

(21) Appl. No.: 11/182,900

(22) Filed: Jul. 18, 2005

Related U.S. Application Data
(60) Provisional application No. 60/592,324, filed on Jul. 30, 2004.

(51) Int. Cl. G09G 5/00

(52) U.S. Cl. 345/582; 345/614

(57) ABSTRACT

One or more fragment programs are executed on a graphics processor to generate the vertices of a subdivision curve or subdivision surface (using an arbitrary subdivision scheme) into a floating point texture. A plurality of faces are simultaneously processed during each subdivision iteration by using a super buffer that contains the vertices, their neighbors, and information about each face. Following the subdivision iterations, the texture is mapped as a vertex array (or a readback is performed), and the subdivided faces are rendered as complex curves or surfaces.

### CROSS-REFERENCE TO RELATED APPLICATIONS

This application claims the benefit of U.S. Provisional Application No. 60/592,324, filed Jul. 30, 2004, by Mech, entitled “Generating Subdivision Surfaces on a Graphics Hardware with Floating-Point Fragment Shaders,” incorporated herein by reference in its entirety.

### BACKGROUND OF THE INVENTION

1. Field of the Invention

The present invention relates generally to producing geometric models for computer graphics, and more specifically, to producing subdivision-based representations of complex geometry.

2. Related Art

Subdivision is an algorithmic technique to generate smooth curves and surfaces as a sequence of successively refined polyhedral meshes. In recent years, subdivision curves have become an important alternative to parametric curves in computer aided design. For a modeler, subdivision curves are attractive because a complex curve can be defined using a small number of control points.

Subdivision surfaces are also popular in the special effect industry and are becoming popular in manufacturing. However, subdivision surfaces are costly to evaluate and store because the original control mesh can be subdivided into a large number of faces. A significant amount of data must be generated on a central or control processing unit (CPU) and passed to a graphics processing unit (GPU) to evaluate the surfaces. This requires a lot of data to be transferred through a bus and/or stored to memory.

Therefore, a need exists to develop a technology that addresses these concerns and facilitates the ability to generate subdivisions curves and surfaces in a timely and cost effective manner.

### SUMMARY OF THE INVENTION

A method, system and computer program product are provided to utilize one or more fragment programs on a graphics processing unit (GPU) to generate the vertices of a subdivision curve or subdivision surface (using an arbitrary subdivision scheme) into a floating point texture. One or more fragment programs also map the texture as a vertex array that is implemented to render complex curves or surfaces on the GPU.

A curve or surface can be specified by a small number of control vertices (forming a control mesh). An initial control mesh is processed in software and an algorithm is used to detect the topology, even for non-manifolds. For each vertex, a list of immediate neighbors is kept in a clockwise order.

The vertex and neighbors are used to prepare a floating point texture. The first several columns of the texture contain vertices and their neighbors, and the rest of the texture contains the initial information about each face of the control mesh.

The subdivision step is simulated on the GPU in several rendering passes. First, the vertices are processed, and for each neighbor, the new coordinates are computed using a fragment program. Also, the face is subdivided by rendering a line for each face representing the newly subdivided face and its immediate neighbors. Additional lines are rendered to set the values for main vertices and their neighbors to the line storing faces.

Following the subdivision step, the texture is mapped as a vertex array (or a readback is performed), and the subdivided faces are rendered.

A substantial amount of texture memory is not required. Thus, the data transfer through the bus is limited. Moreover, a plurality of faces can be processed in parallel.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable one skilled in the pertinent art(s) to make and use the invention. In the drawings, generally, like reference numbers indicate identical or functionally or structurally similar elements. Additionally, generally, the leftmost digit(s) of a reference number identifies the drawing in which the reference number first appears.

FIG. 1 illustrates a computer architecture.

FIG. 2 illustrates a graphics system.

FIG. 3 illustrates an operational flow for producing subdivisions on a graphics processing unit.

FIG. 4 illustrates an operational flow for simulating a subdivision.

FIG. 5 illustrates operation of an L-System on a graphics processing unit to generate subdivision curves.

FIG. 6 illustrates an operational flow for generating subdivisions of a closed curve.

FIG. 7 illustrates another operation of an L-System on a graphics processing unit to generate subdivision curves.

FIG. 8 illustrates an example of closed and open subdivision curves generated with an L-System implemented on a graphics processing unit.

FIG. 9 illustrates an input texture for a Loop Subdivision scheme.

FIG. 10 illustrates operation of a super buffer that can implemented to generate subdivision surfaces.

FIG. 11 illustrates operation of multiple super buffers that can be implemented to generate subdivision surfaces.

FIG. 12 illustrates another operation of multiple super buffers that can be implemented to generate subdivision surfaces.

FIG. 13 illustrates an input texture for a Catmull-Clark subdivision scheme.

FIG. 14 illustrates an example computer system.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the relevant art(s) to effect such feature, structure, or characteristic in connection with other embodiments whether or not explicitly described.

A method, system and computer program product are provided to produce subdivision-based representations of complex geometry on a graphics processing unit (GPU) having floating-point pixel shaders. One or more fragment programs are utilized on the GPU to generate the vertices of a subdivision curve or subdivision surface. The vertices are generated in a floating point texture, and the texture is mapped as a vertex array that is used to render complex curves or surfaces on the GPU. The present invention supports any arbitrary subdivision scheme, including, but not limited to, Chaikin, B-Spline, Dyn-Levyn-Gregory, Loop, Catmull-Clark, Modified Butterfly, Kobbelt, Doo-Sabin, Midedge, or the like. Several examples for generating subdivision curves and surfaces on a GPU are described in Appendix A of the application entitled “Generating Subdivision Surfaces on a Graphics Hardware with Floating-Point Fragment Shaders” (U.S. Provisional App. 60/592,324), which is incorporated herein by reference as though set forth in its entirety.

I. Terminology

The following terms are defined so that they may be used to describe embodiments of the present invention. As used herein:

“Pixel” means a data structure, which is used to represent a picture element. Any type of pixel format can be used.

“Real-time” or “Interactive Rate” refers to a rate at which successive display images can be redrawn without undue delay upon a user or application. This can include, but is not limited to, a nominal rate of between 30-60 frames/second. In some example embodiments, such as some flight simulators or some interactive computer games, an interactive rate may be approximately 10 frames/second. In some examples, real-time can be one update per second. These examples are illustrative of real-time rates; in general, smaller or larger rates may be considered “real-time” depending upon a particular use or application.

“Texture” refers to image data or other type of data that can be mapped to an object to provide additional surface detail or other effects. In computer graphics applications, texture is often a data structure including, but not limited to, an array of texels. A texel can include, but is not limited to, a color value or an intensity value. These texel values are used in rendering to determine a value for a pixel. As used herein, the term “texture” includes, for example, texture maps, bump maps, and gloss maps.

“Texture sample” refers to a sample selected from a texture map or texture. The sample can represent one texel value or can be formed from two or more texel values blended together. Different weighting factors can be used for each texel blended together to form a texel. The terms “texel” and “texture sample” are sometimes used interchangeably.

“Texture unit” refers to graphics hardware, firmware, and/or software that can be used to obtain a texture sample (e.g., a point sample or a filtered texture sample) from a texture. A texture unit can in some embodiments obtain multiple texture samples from multiple textures.

II. Example Architecture

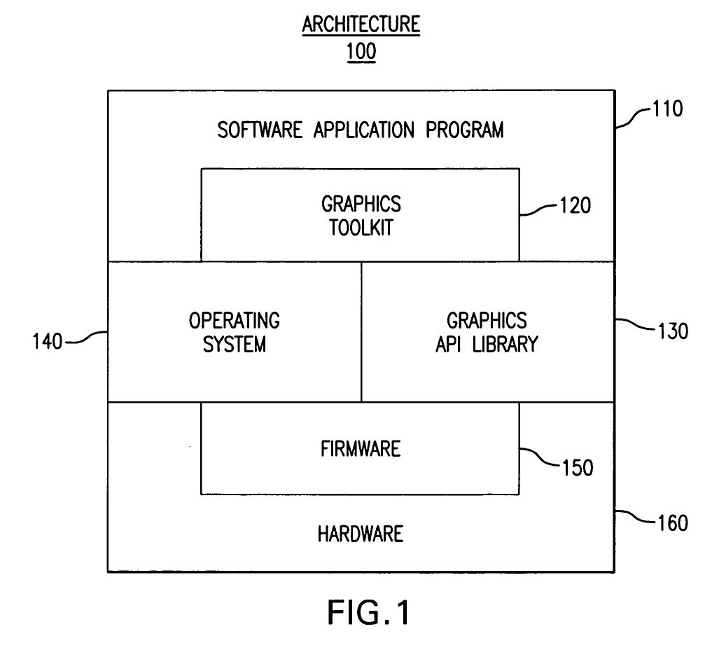

FIG. 1 illustrates a block diagram of an example computer architecture 100 in which the various features of the present invention can be implemented. This example architecture 100 is illustrative and not intended to limit the present invention. It is an advantage of the invention that it may be implemented in many different ways, in many environments, and on many different computers or computer systems.

Architecture 100 includes six overlapping layers 110-160. Layer 110 represents a high level software application program. Layer 120 represents a three-dimensional (3D) graphics software tool kit, such as the OPENGL PERFORMER™ toolkit available from Silicon Graphics, Inc. (Mountain View, Calif.). Layer 130 represents a graphics application programming interface (API), which can include but is not limited to the OPENGL (R) API available from Silicon Graphics, Inc. (Mountain View, Calif.). Layer 140 represents system support such as operating system and/or windowing system support. Layer 150 represents firmware. Finally, layer 160 represents hardware, including graphics hardware. Hardware 160 can be any hardware or graphics hardware including, but not limited to, a computer graphics processor (single chip or multiple chip), a specially designed computer, an interactive graphics machine, a gaming platform, a low end game system, a game console, a network architecture, et cetera.

In other embodiments, less than all of the layers 110-160 of architecture 100 can be implemented. As will be apparent to a person skilled in the relevant art(s) after reading the description herein, various features of the present invention can be implemented in any one of the layers 110-160 of architecture 100, or in any combination of layers 110-160 of architecture 100.

III. Example System Embodiment

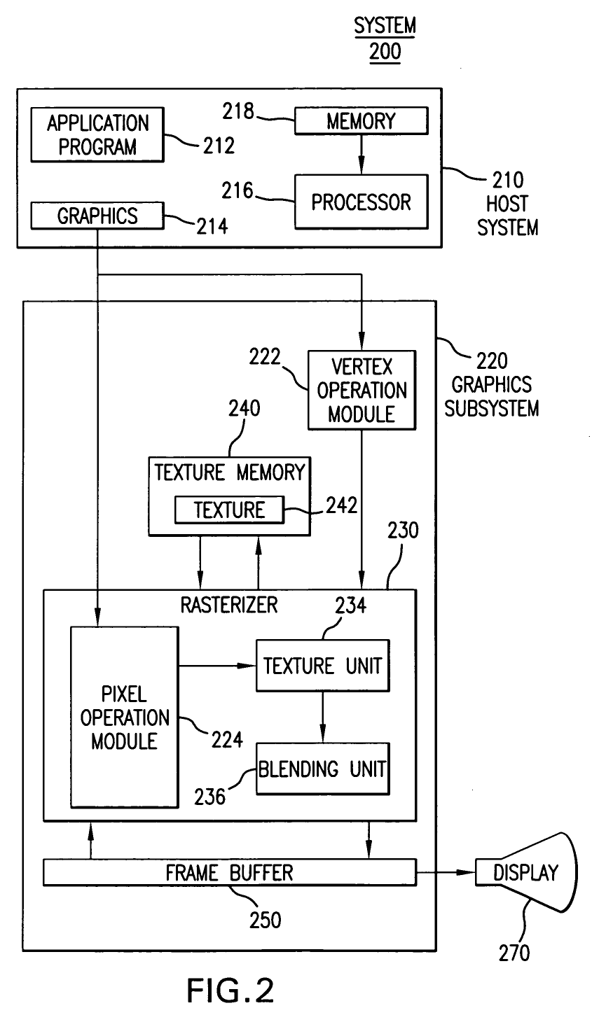

FIG. 2 illustrates an example graphics system 200. Graphics system 200 comprises a host system 210, a graphics subsystem 220, and a display 270. Each of these features of graphics system 200 is further described below.

Host system 210 comprises an application program 212, a hardware interface or graphics API 214, a processor 216, and a memory 218. Application program 212 can be any program requiring the rendering of a computer image. The computer code of application program 212 is executed by processor 216. Application program 212 assesses the features of graphics subsystem 220 and display 270 through hardware interface or graphics API 214. Memory 218 stores information used by application program 212.

Graphics subsystem 220 comprises a vertex operation module 222, a rasterizer 230, a texture memory 240, and a frame buffer 250. Texture memory 240 can store one or more textures or images, such as texture 242. Texture memory 240 is connected to a texture unit 234 by a bus (not shown). Rasterizer 230 comprises a pixel operation module 224, a texture unit 234 and a blending unit 236. Texture unit 234 and blending unit 236 can be implemented separately or together as part of a graphics processor.

In an embodiment, texture unit 234 can obtain multiple point samples or multiple filtered texture samples from textures and/or images stored in texture memory 240. Blending unit 236 blends texels and/or pixel values according to weighting values to produce a single texel or pixel. The output of texture unit 234 and/or blending unit 236 is stored in frame buffer 250. Display 270 can be used to display images stored in frame buffer 250.

FIG. 2 shows a multipass graphics pipeline. It is capable of operating on each pixel of an image (object) during each pass that the image makes through the graphics pipeline. For each pixel of the image, during each pass that the image makes through the graphics pipeline, texture unit 234 can obtain at least one texture sample from the textures and/or data stored in texture memory 240. Although FIG. 2 shows a multipass graphics pipeline, it is noted here that other embodiments do not have a multipass graphics pipeline. As described below, method embodiments can be implemented using systems that do not have a multipass graphics pipeline.

IV. Example Method Embodiments

According to embodiments, a method, system, and computer program product is provided to utilize one or more fragment programs on a graphics processing unit (GPU), such as graphics subsystem 220, and generate the vertices of a subdivision curve or subdivision surface (using an arbitrary subdivision scheme) into a floating point texture and then map the texture as a vertex array and very quickly render complex curves or surfaces on the GPU. A curve or surface can be specified by a small number of control vertices (forming a control mesh) and thus the data transfer through the bus is limited.

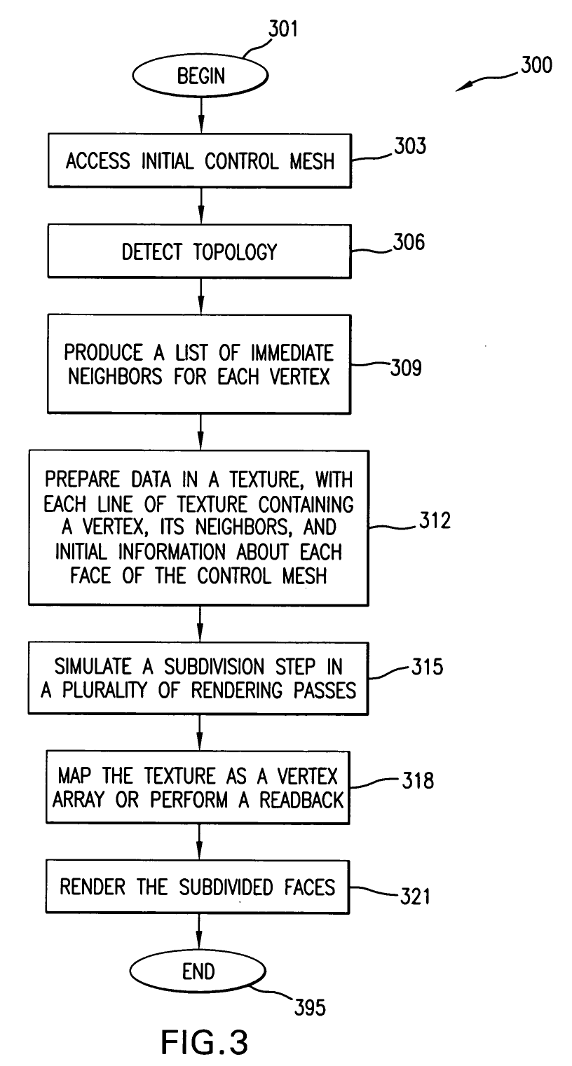

Referring to FIG. 3, flowchart 300 represents the general operational flow of an embodiment for rendering complex geometry. More specifically, flowchart 300 shows an example of a control flow for producing subdivisions on a GPU.

The control flow of flowchart 300 begins at step 301 and passes immediately to step 303. At step 303, an initial control mesh is accessed and at step 306, the control mesh is processed in a software application. An algorithm detects the topology, including any non-manifolds.

At step 309, the immediate neighbors for each vertex are listed in a clockwise order. If a new vertex is inserted that breaks the manifold topology, separate loops of neighbors are produced, and at the end of the processing, the vertex is split into several vertices (with the same coordinate) and kept in a linked list.

At step 312, data is prepared in a texture. First, several columns of the texture contain vertices and their neighbors. Each line of texture includes one vertex and its neighbors. The rest of the texture includes the initial information about each face of the control mesh—for example quads (for, e.g., Catmull-Clark subdivisions), triangles (for, e.g., Loop subdivisions), hexagons, or the like. These vertices are stored in one line each.

At step 315, a subdivision step is simulated on the GPU in a plurality of rendering passes. At step 318, the texture is mapped as a vertex array, or a readback is performed. At step 321, the subdivided faces are rendered. After rendering the subdivision, the control flow ends as indicated at step 395.

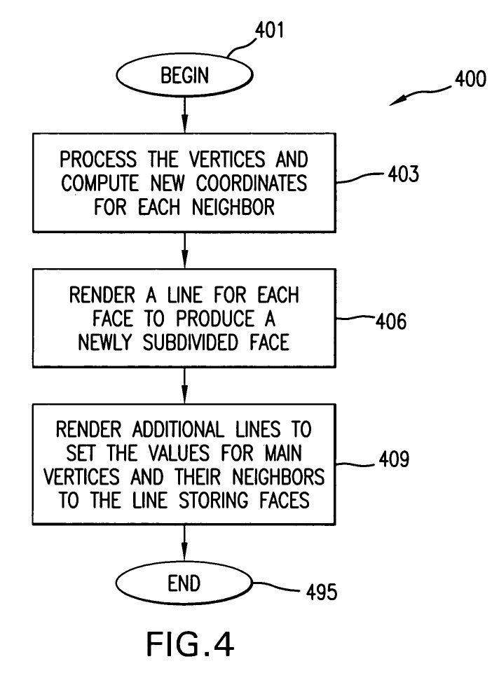

As discussed at step 315, a method is provided for simulating a subdivision step in a plurality of rendering passes. A general operational flow for simulating a subdivision is described with reference to FIG. 4. Thus as depicted in FIG. 4, flowchart 400 shows an example of a control flow for executing step 315.

The control flow of flowchart 400 begins at step 401 and passes immediately to step 403. At step 403, the vertices are processed. For each neighbor, new coordinates are computed using a fragment program.

At step 406, a face is subdivided by rendering a line for each face representing the newly subdivided face and its immediate neighbors. At step 409, additional lines are rendered to set the values for main vertices and their neighbors to the line storing faces. As a result, the faces can be processed with vertices of arbitrary valence. Afterwards, the control flow ends as indicated at step 495.

As described above in flowcharts 300 and 400, subdivisions can be rendered by mapping textures as a vertex array and rendering directly from the vertex array. As such, the above approach do not require a significant amount of texture memory. In additional, a plurality of faces can be processed in parallel.

V. Example Method Embodiments for Generating Subdivision Curves

Various techniques are provided for generating subdivision curves on a GPU. Although the generation of subdivision curves are described with reference to the Lindenmeyer system (L-system) scripting language, other programmable languages can be used and are deemed to be within the scope of the present invention.

The L-systems are described herein as being implemented on a GPU. The GPU can be programmed using assembler level languages or higher level languages, such as the C for Graphics (Cg) programming language, the high-level shader language (HLSL) included in the DIRECTX (R) version 9.0 software development kit available from Microsoft Corporation (Redmond, Wash.), the RADEON™ 9700 graphics card available from ATI Technologies Inc. (Ontario, Canada), or the like.

Subdivision curves can be described using context-sensitive parametric L-systems. Techniques for describing subdivision curves with parametric L-systems are described by Przemyslaw Prusinkiewicz et al. in the article “L-system Description of Subdivision Curves,” International Journal of Shape Modeling, (2003). According to embodiments, control points of the subdivision curve are stored as symbols in an initial string, with parameters specifying point locations. It should be noted that a distinction is made between the location of a point (e.g., three coordinates) and the position of the point in the string (e.g., an index value).

L-system productions are used to replace each point with new points according to a subdivision scheme. The present invention can be modified to support any type of subdivision scheme, including, but not limited to, Chaikin, B-Spline, Dyn-Levyn-Gregory, or the like.

A Chaikin subdivision of a closed curve can be captured by a single production as shown by Equation 1 below:

$$Equation 1 \text{:}$$

$$P ( vl ) < P ( v ) > P ( vr ) \to P ( \frac{1}{4} vl + \frac{3}{4} v ) P ( \frac{3}{4} v + \frac{1}{4} vr )$$

Equation 1 replaces one point (the strict predecessor) with two new points that form the successor. The location of each new point is an affine combination of the locations v, vl and vr of the predecessor point and its context (neighbors).

Equation 1 can be modified to express different subdivision schemes, with each scheme using a different affine combination of the neighbors. For example, Equation 2, below, uses more than one neighbor on each side of a point, and can be expressed as:

$$Equation 2 \text{:}$$

$$P ( v 0 ) P ( v 1 ) < P ( v 2 ) > P ( v 3 ) P ( v 4 ) \to P ( {\sum }_{i = 0}^{4} a [ i ] \cdot vi ) P ( {\sum }_{i = 0}^{4} b [ i ] \cdot vi )$$

In Equation 2, the arrays a and b store parameters of the affine combination for each new symbol. Equation 2 expresses a Chaikin subdivision scheme when a={0, ¼, ¾, 0, 0} and b={0, 0, ¾, ¼, 0}, a cubic B-Spline subdivision when a={0, ⅛, ¾, ⅛, 0} and b={0, 0, ½, ½, 0}, and a Dyn-Levin-Gregory (4-point) subdivision when a={0, 0, 1, 0, 0} and b={0, 1/16, 9/16, 9/16, − 1/16}.

The present invention also supports the generation of open subdivision curves. For open subdivision curves, the endpoints of the curve do not change location, and the rules for creating new points in their neighborhood are different from those operating farther from the endpoints. If the endpoints are denoted by symbol E, Equation 1 can be expanded to open curves as shown in the following Equation 3:

$$Equation 3 \text{:}$$

$$p 1 \text{:} E ( v l ) < P ( v ) > P ( vr ) \to P ( \frac{1}{2} vl + \frac{1}{2} v ) P ( \frac{3}{4} v + \frac{1}{4} vr )$$

$$p 2 \text{:} P ( vl ) < P ( v ) > E ( vr ) \to P ( \frac{1}{4} vl + \frac{3}{4} v ) P ( \frac{1}{2} v + \frac{1}{2} vr )$$

$$p 3 \text{:} P ( vl ) < P ( v ) > P ( vr ) \to P ( \frac{1}{4} vl + \frac{3}{4} v ) P ( \frac{3}{4} v + \frac{1}{4} vr )$$

$$p 4 \text{:} E ( v ) \to E ( v )$$

Equation 3 can be generalized in a similar manner to Equation 1. The proper handling of endpoints requires two additional productions as shown in Equation 4, which uses more than one neighbor on each side of a point:

$$Equation 4 \text{:}$$

$$p 1 \text{:} E ( v 0 ) P ( v 1 ) < P ( v 2 ) > P ( v 3 ) P ( v 4 ) \to P ( {\sum }_{i = 0}^{4} a [ 0 ] [ i ] \cdot vi ) P ( {\sum }_{i = 0}^{4} b [ 0 ] [ i ] \cdot vi )$$

$$p 2 \text{:} E ( v 1 ) < P ( v 2 ) > P ( v 3 ) P ( v 4 ) \to P ( {\sum }_{i = 0}^{4} a [ 1 ] [ i ] \cdot vi ) P ( {\sum }_{i = 0}^{4} b [ 1 ] [ i ] \cdot vi )$$

$$p 3 \text{:} P ( v 0 ) P ( v 1 ) < P ( v 2 ) > P ( v 3 ) E ( v 4 ) \to P ( {\sum }_{i = 0}^{4} a [ 2 ] [ i ] \cdot vi ) P ( {\sum }_{i = 0}^{4} b [ 2 ] [ i ] \cdot vi )$$

$$p 4 \text{:} P ( v 0 ) P ( v 1 ) < P ( v 2 ) > E ( v 3 ) \to P ( {\sum }_{i = 0}^{3} a [ 3 ] [ i ] \cdot vi ) P ( {\sum }_{i = 0}^{3} b [ 3 ] [ i ] \cdot vi )$$

$$p 5 \text{:} P ( v 0 ) P ( v 1 ) < P ( v 2 ) > P ( v 3 ) P ( v 4 ) \to P ( {\sum }_{i = 0}^{4} a [ 4 ] [ i ] \cdot vi ) P ( {\sum }_{i = 0}^{4} b [ 4 ] [ i ] \cdot vi )$$

$$p 6 \text{:} E ( v ) \to E ( v )$$

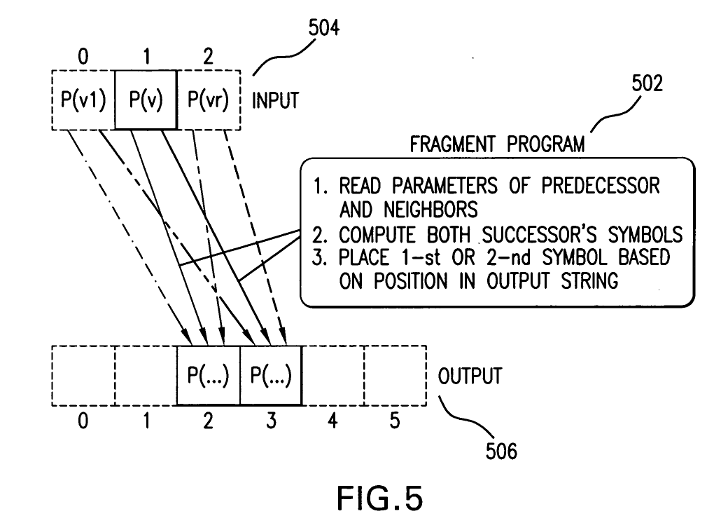

As described below with reference to FIGS. 5-7, Equations 1-4 are implemented directly on a GPU. As shown in FIG. 5, an L-system in which each symbol is replaced by a constant number of k symbols (for example, Equation 1 or Equation 2) can be implemented on graphics hardware that supports floating-point fragment programs 502 (e.g., pixel shaders).

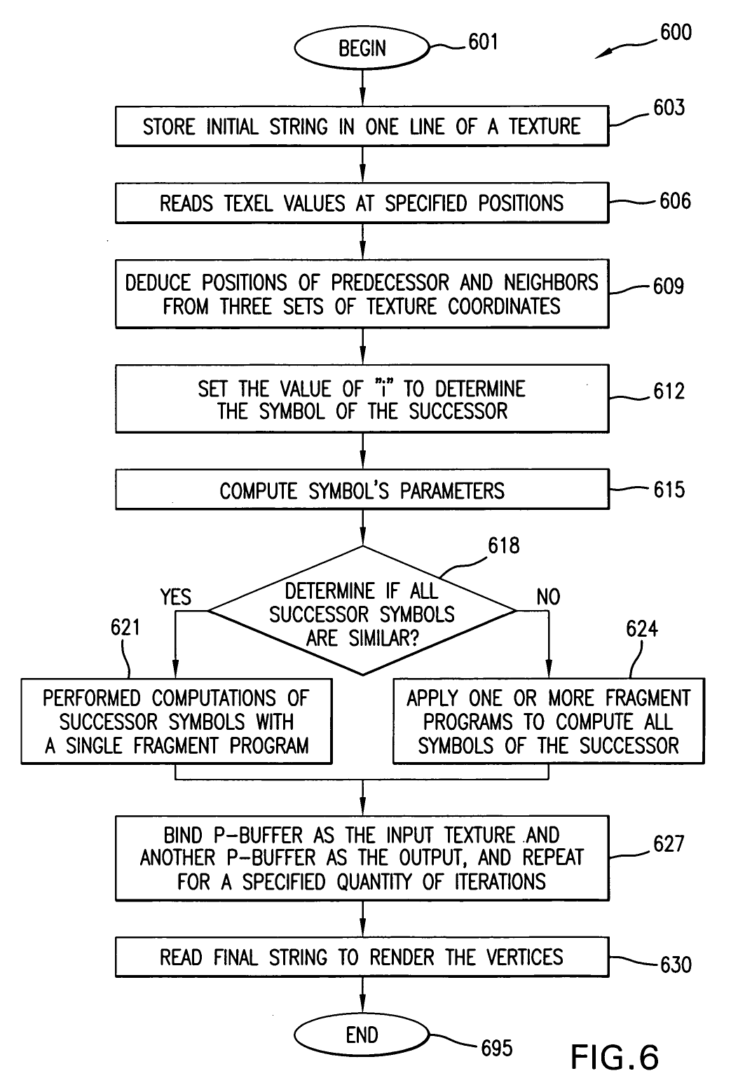

Referring to FIG. 6, flowchart 600 shows an example of a control flow for generating subdivisions of a closed curve. The control flow of flowchart 600 begins at step 601 and passes immediately to step 603. At step 603, the initial string is stored in one line of a texture (e.g., input texture 504 in FIG. 5). If one line is not enough, the neighbor selection process is modified in order to store the string in a two-dimensional texture. The letter symbol of each point is in the alpha channel, and the coordinates are in the red-green-blue (RGB) channels. Given an input string of length n, a line of length kn is drawn into a P-buffer, off-screen memory located on a graphics card. A pixel of the line at position i represents the i % k-th point of the successor of the i/k-th symbol in the input string.

As the line is rendered, at step 606, the fragment program (e.g., fragment program 502 in FIG. 5) reads texel values at positions (i/k−1)% n, (i/k)% n and (i/k+1)% n (the left context, the strict predecessor, and the right context), and sets the value of pixel i as defined for the i % k-th point of the production successor.

At step 609, the positions of the predecessor and neighbors are deduced from three sets of texture coordinates. The texture coordinates of neighbors are shifted to the left and right from the predecessor coordinates.

At step 612, the value of i used to determine the symbol of the successor is set using a one dimensional texture coordinate with values of “0” and kn assigned with the two vertices of the line.

Once the symbol of the successor is identified, at step 615, the fragment program (e.g., fragment program 502 in FIG. 5) has to compute symbol's parameters. If, at step 618, the computations for all successor symbols are similar, such as in case of Equation 2, they can be performed by a single fragment program (e.g., fragment program 502 in FIG. 5) at step 621. The single fragment program can be written using a set of local fragment program parameters or an input texture to specify different parameters for each computation (equivalent to arrays a and b in Equation 2). The correct set of parameters is selected based on the symbol's position i in the final string.

However if, at step 618, the computations vary significantly, they cannot be expressed by a single formula that uses different parameters for different symbols of the successor. In this case, at step 624, a fragment program (e.g., fragment program 502 in FIG. 5) is applied that computes all symbols of the successor and selects the one identified by position i. If these computations do not fit into a single fragment program, we can use a set of fragment programs applied one after another, each setting only a particular symbol of the successor.

At step 627, the P-buffer is bound as the input texture (e.g., input texture 504 in FIG. 5) and another P-buffer is used as the output (e.g., output texture 506 in FIG. 5). This step is repeated for each subsequent iteration.

At step 630, the final string is read using, for example, the OPENGL (R) command “g1ReadPixels” to render the vertices. If the drivers can support rendering into a vertex array, it is possible to avoid the readback. After rendering the vertices, the control flow ends at step 695.

If an L-system has more than one production, and they have successors of different length (for example, Equation 3), there are two issues: to find a production for each symbol, and to position the successor in the output string. There are two approaches to finding the production. If the productions are of a similar form and the coefficients used to compute the successor's parameters can be tabulated, such as in Equations 3 or 4, two fragment programs can be used, one to find an applicable production and one to apply it. These programs use textures that specify the correspondence between a specific predecessor and its successor, given the predecessor's context (see below for more details). If L-system productions vary significantly, it is necessary to represent each production or a group of similar productions using a separate fragment program.

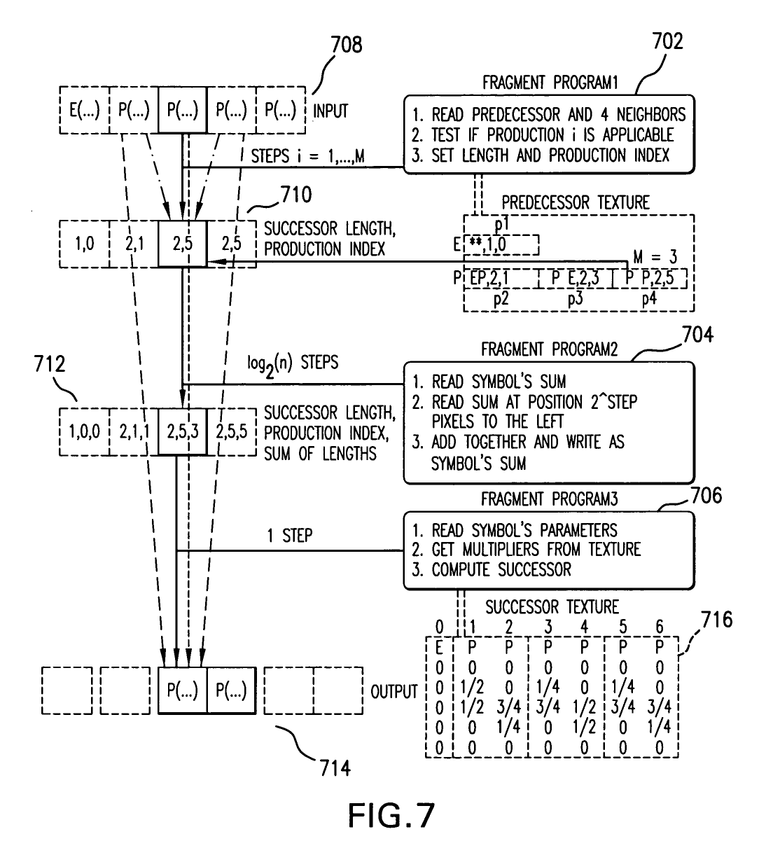

The first approach is more desirable because a user can modify the L-system by changing texture data without any changes to fragment programs. All productions are specified using two textures: the predecessor texture and the successor texture. Each row of the predecessor texture stores information on the context of all productions with the same strict predecessor. Each production is specified by its four neighbors, the successor length and the index of the first symbol of the successor in the successor texture (see FIG. 7). Optionally, for each production, the row can also store coefficients used to evaluate the production's condition. Each column of the successor texture stores the symbols and affine combination coefficients for one successor symbol of one production.

FIG. 7 illustrates the operation of an L-system using textures organized as described above. Fragment program 702 finds the matching production for each point in the predecessor string 708, and outputs the successor length “1” and the index “s” of the first symbol of the successor, stored in the successor texture 710. Since the program 702 tests one set of neighbors at a time, this takes up to M passes, where “M” is the maximum number of productions with the same strict predecessor.

To determine the position of each successor in the output string 714, we simulate the scan-add operation. By definition, if y=scan-add(x), then y[0]=0 and y[i]=Σⱼ₌₁ⁱ⁻¹x[j]. As can be seen, the scan-add operation does not add the value at the given position to the sum. Before the productions are applied, fragment program 704 is run, which sums the lengths of all successors to the left of a given symbol. This can be done in [log₂(n)] passes. These sums are read with, for example, the OPENGL (R) command “g1ReadPixels” and used to create a set of line segments on a GPU, each starting at the pixel given by a sum (see 712). Again, the readback can be avoided if rendering into vertex arrays is supported in drivers.

The one-dimensional texture coordinates at vertices of each line segment (see 712) are set to s and s+1. Fragment program 706, executed for each pixel of each line segment, accesses the successor texture column (see 716) identified by the one-dimensional texture coordinate (see 712). It retrieves the symbol and its affine combination coefficients from the texture, computes the affine combination of the predecessor point and its neighbors, and sets the new symbol and the computed value (see 714).

If a set of productions include successors with the same length, the scan-add step can be skipped. A single line of length kn is drawn as in flowchart 600 and the position i is used to determine the symbol of the successor in fragment program 706. Sometimes the successor can be determined from the position i even if the productions have successors of different length. In Equation 3, for example, only the first and last symbol in the string produce one new symbol, all other symbols produce two, and therefore the position of each successor can be determined in advance.

In the subsequent iteration of the subdivision process, the P-buffer 714 is used as an input texture for the fragment programs (702, 704, and 706). The final string is read with, for example, the OPENGL (R) command “g1ReadPixels,” and the vertices are rendered as in the closed curve case.

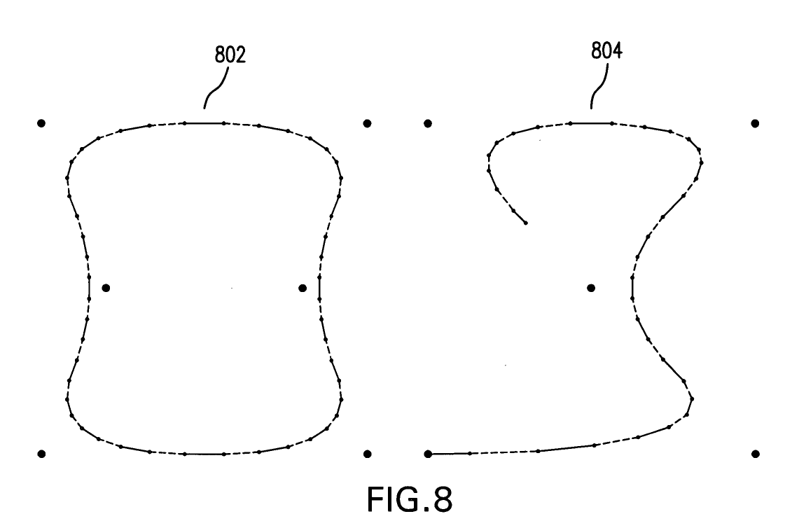

FIG. 8 shows sample subdivision curves 802 and 804, which are generated using Equations 2, 3 and 4 implemented on the RADEON™ 9700 graphics card available from ATI Technologies Inc. (Ontario, Canada). In the case of closed curve 802, the control flow of flowchart 600 was executed. A single fragment program generates both new points of the successor in a single rendering pass. The arrays a and b (see Equation 2) are set using local parameters of the fragment program. The program has fifteen instructions (i.e., twelve arithmetic instructions and three texture reads). It took 0.4 milliseconds to generate closed curve 802, out of which 0.3 milliseconds were spent in switching the rendering context from one P-buffer to another. One context switch took about 0.1 milliseconds. The overhead of context switches can be reduced if several curves are evaluated at once. Subdividing a curve defined by four control points eight times (i.e., subdivision level 8) resulted in 1024 points and took (8*0.1+0.2) milliseconds. These times do not include the final readback, which for 1024 points takes about 0.17 milliseconds.

Using a software implementation on a 2.4 GHz Pentium 4 CPU to generate three levels of subdivision took about the same time (0.1 milliseconds), but at higher subdivision levels the GPU implementation became faster (if the context switch overhead is discounted). At subdivision level 8, the GPU was about twice as fast as the CPU.

In the case of open curve 804, method described in FIG. 7 is implemented. The L-system is parsed into the predecessor texture and successor texture. Fragment program 702 has forty-five instructions (i.e., thirty-five arithmetic instructions plus ten texture reads), fragment program 704 has twenty-four instructions (i.e., sixteen plus eight), and fragment program 706 has eighteen instructions (i.e., fifteen plus three). It took 2.1 milliseconds to generate open curve 804 in FIG. 8, out of which 1.35 milliseconds were spent on eleven context switches and 0.3 milliseconds on three readbacks after each scan-add operation. The overall time of 2.1 milliseconds can be reduced by 0.9 milliseconds (i.e., five context switches 0.4 milliseconds) by skipping the scan-add operation, because in Equation 3 the position of each production successor can quickly be determined.

The software implementation of open subdivision curves (e.g., open curve 804) is faster than the GPU implementation for a small number of control points. Subdividing open curve 804 up to level 8 is four times faster in software (discounting the cost of context switches). The GPU disadvantage is caused by having to perform several rendering passes to find a production, and several passes to perform scan-add operation, while dealing with a relatively small number of pixels. Once the number of pixels is increased by evaluating several curves in parallel, the GPU algorithm becomes relatively faster. Evaluating sixteen open curves (8 subdivision levels) took about the same time on the CPU and the GPU, and for thirty-two curves the GPU is about fifty percent faster. Consequently, using the GPU for evaluating subdivision curves is advantageous if one needs to evaluate many of them at once.

VI. Example Method Embodiments for Generating Subdivision Surfaces

As discussed above, a set of fragment programs can be created on a GPU that implements L-systems capable of generating subdivision curves. As the results indicate, the GPU implementation becomes faster compared to CPU implementation when many curves are evaluated at once. In another embodiment, the above methods are extended to subdivision surfaces, where the advantage of a GPU implementation is likely to be more significant, because a larger number of points are being processed. As discussed above, the present invention can be implemented with any type of subdivision scheme for generating surfaces, including, but not limited to, Loop, Catmull-Clark, Modified Butterfly, Kobbelt, Doo-Sabin, Midedge, or the like.

In an embodiment, a Loop subdivision scheme is used to produce an arbitrary control mesh. As described above with reference to steps 303-309 in FIG. 3, the control mesh is processed to detect the topology. For non-manifold surfaces, each vertex is split when loading a mesh so that its neighbor is manifold.

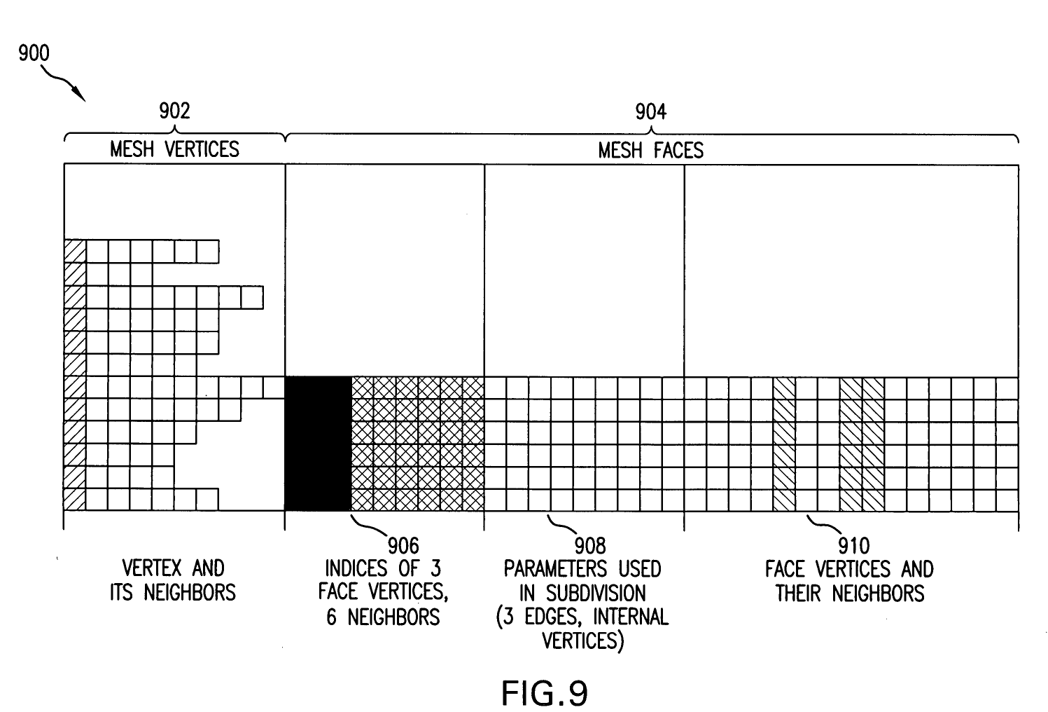

The vertices of the control mesh are used to produce an input texture as discussed above at step 312. FIG. 9 illustrates an embodiment of an input texture 900. As shown, input texture 900 includes mesh vertices 902, which lists each vertex and the neighbors for each vertex. Input texture 900 also includes mesh faces data 904. Mesh faces data 904 includes indices 906 of three face vertices and six neighbors. Mesh faces data 904 includes parameters 908 that are used in a subdivision (e.g., three edges, internal vertices, etc.). Mesh faces data 904 also includes face vertices and their neighbors (collectively referred to as 910).

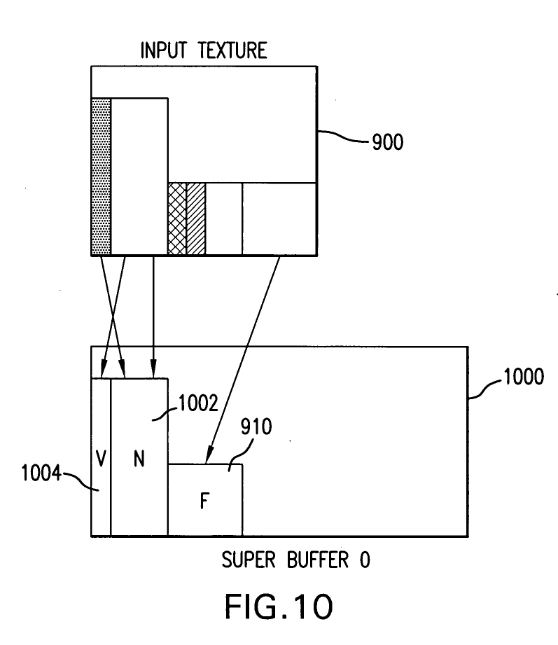

Referring back to flowchart 400 in FIG. 4, input texture 900 is processed to simulate a subdivision. Prior to initiating a subdivision step, input texture 900 is mapped to a super buffer. FIG. 10 illustrates a super buffer 1000 that can be used to implement the subdivision methods of the present invention. More specifically, super buffer 1000 is prepared prior to the initial subdivision step. As shown, neighbors 1002 and vertices 1004 are computed for the initial subdivision step from input texture 900, and placed in super buffer 1000. Additionally, a copy of face vertices 910 are placed in super buffer 1000.

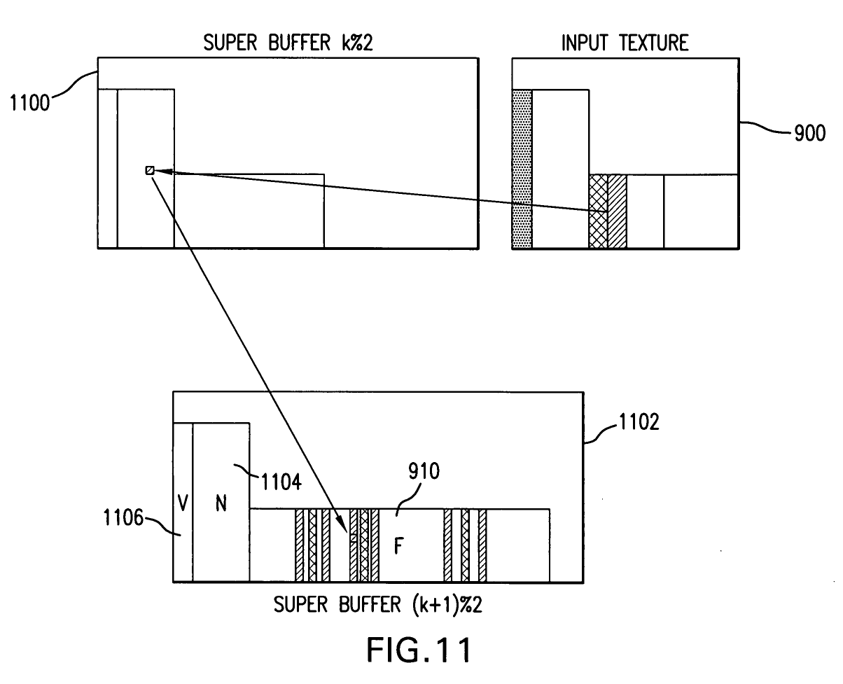

Once super buffer 1000 is prepared, the initial subdivision can begin. FIG. 11 shows an input texture 900 and two super buffers 1100 and 1102 for implementing a subdivision step “k”, where “k” in the maximum number of iterations for successively refining a polyhedral mesh. Initially, super buffer 1000 becomes super buffer 1100. As shown, first, the neighbors 1104 and vertices 1106 for a subsequent step (i.e., k+1) are computed and placed in super buffer 1102. A copy of face vertices 910 are also placed in super buffer 1102. For each subsequent iteration, super buffer 1102 replaces super buffer 1100, which is processed to write the results of the next computation in super buffer 1102.

Normals and texture coordinates are also processing during each subdivision iteration. For each vertex, the normals are averaged for all adjacent faces. As for the texture coordinates, they are linearly interpolated across each face in a single step.

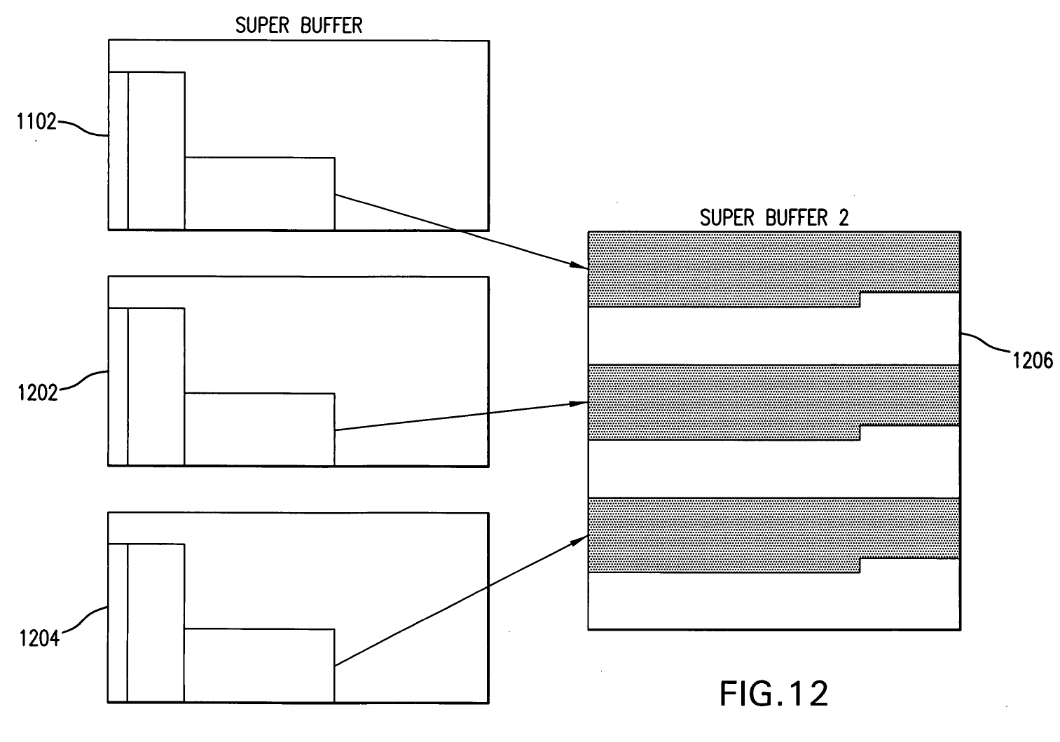

Upon conclusion of the subdivision iterations, the vertices, normals, and texture coordinates are written to super buffer 1102, super buffer 1202, and super buffer 1204, respectively, as shown in FIG. 12. Afterwards, the contents of buffers 1102, 1202, and 1204 are written to a single super buffer 1206. Super buffer 1206 is attached to vertex array attributes, and the surface is rendered, as described above.

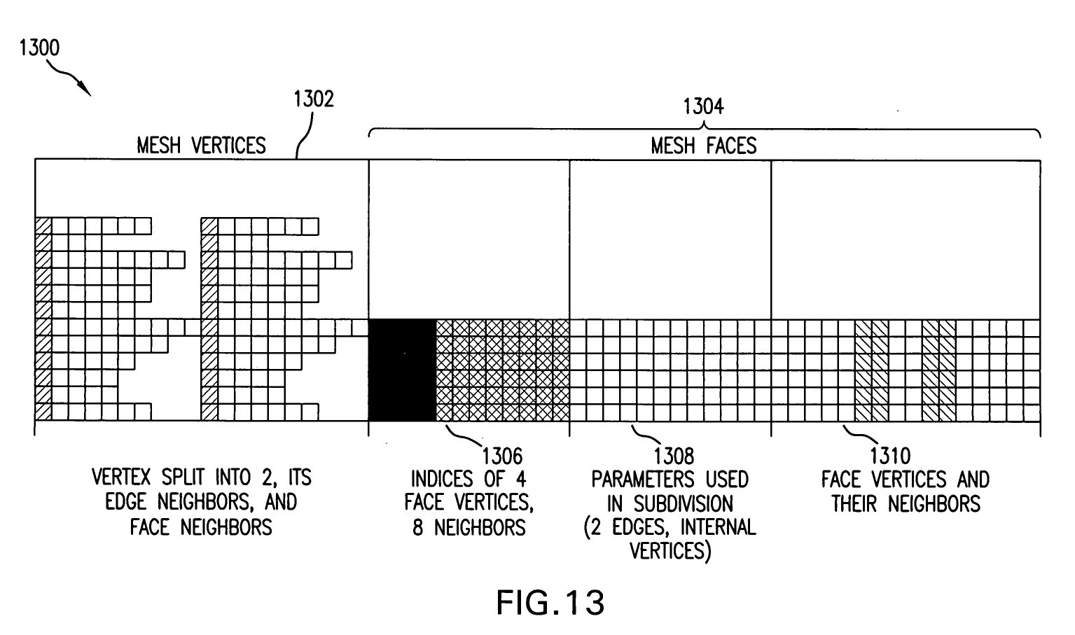

In another embodiment, a Catmull-Clark subdivision scheme is used to produce an arbitrary control mesh. FIG. 13 illustrates an embodiment of an input texture 1300 that can be used to generate a subdivision surface based on a Catmull-Clark scheme. As shown, input texture 1300 includes mesh vertices 1302, which lists each vertex and the neighbors for each vertex. As shown, mesh vertices 1302 are split into groups: one group listing edge neighbors, and a second group listing face neighbors.

Input texture 1300 also includes mesh faces data 1304. Mesh faces data 1304 includes indices 1306 of four face vertices and eight neighbors. Mesh faces data 1304 includes parameters 1308 that are used in a subdivision (e.g., two edges, internal vertices, etc.). Mesh faces data 1304 also includes face vertices and their neighbors (collectively referred to as 1310).

As described above with reference to input texture 900 that can be used with a Loop subdivision scheme, input texture 1300 is processed to simulate a subdivision. Super buffers are used to hold the computations for vertices, normals, and texture coordinates for a predetermined number of iterations “k”. Afterwards, the contents of the super buffers are written to a single super buffer that is attached to vertex array attributes, and the subdivision surface is rendered, as described above.

VII. Example Computer System

FIGS. 1-13 are conceptual illustrations allowing an explanation of the present invention. It should be understood that embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

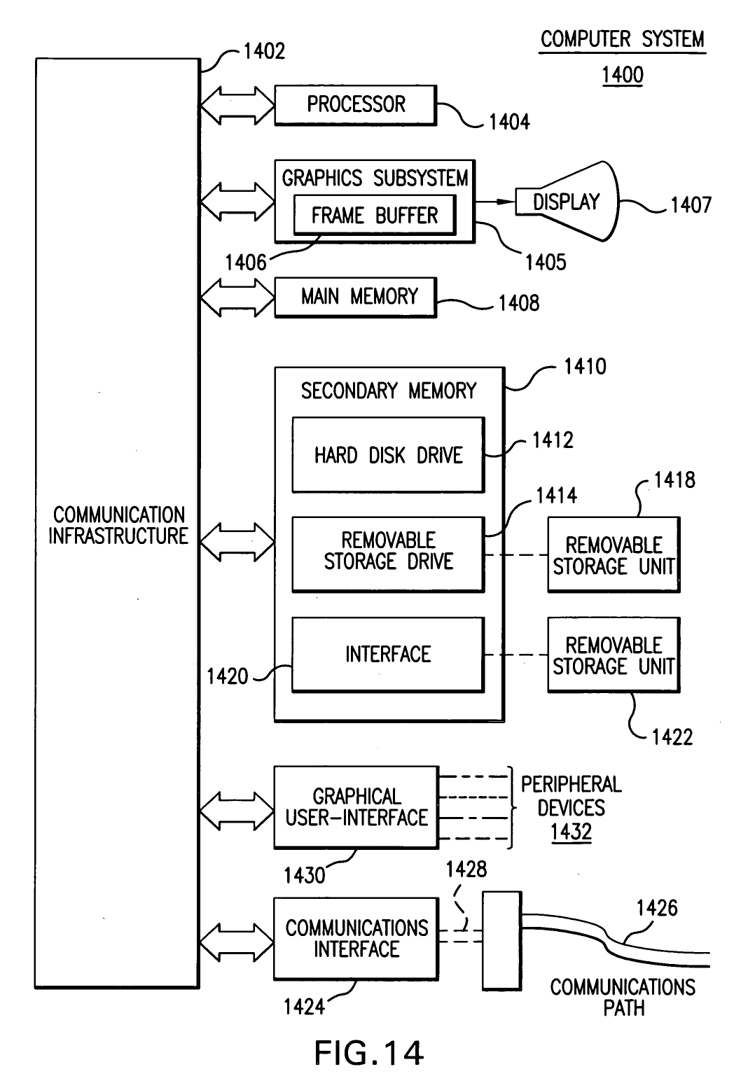

The present invention can be implemented in one or more computer systems capable of carrying out the functionality described herein. FIG. 14 illustrates an example of a computer system 1400 that can be used to implement computer program product embodiments of the present invention. This example computer system is illustrative and not intended to limit the present invention. Computer system 1400 represents any single or multi-processor computer. Single-threaded and multi-threaded computers can be used. Unified or distributed memory systems can be used.

Computer system 1400 includes one or more processors, such as processor 1404, and one or more graphics subsystems, such as graphics subsystem 1405. One or more processors 1404 and one or more graphics subsystems 1405 can execute software and implement all or part of the features of the present invention described herein. Graphics subsystem 1405 forwards graphics, text, and other data from the communication infrastructure 1402 or from a frame buffer 1406 for display on the display 1407. Graphics subsystem 1405 can be implemented, for example, on a single chip as a part of processor 1404, or it can be implemented on one or more separate chips located on a graphic board. Each processor 1404 is connected to a communication infrastructure 1402 (e.g., a communications bus, cross-bar, or network). After reading this description, it will become apparent to a person skilled in the relevant art how to implement the invention using other computer systems and/or computer architectures.

Computer system 1400 also includes a main memory 1408, preferably random access memory (RAM), and can also include secondary memory 1410. Secondary memory 1410 can include, for example, a hard disk drive 1412 and/or a removable storage drive 1414, representing a floppy disk drive, a magnetic tape drive, an optical disk drive, etc. The removable storage drive 1414 reads from and/or writes to a removable storage unit 1418 in a well-known manner. Removable storage unit 1418 represents a floppy disk, magnetic tape, optical disk, etc., which is read by and written to by removable storage drive 1414. As will be appreciated, the removable storage unit 1418 includes a computer usable storage medium having stored therein computer software (e.g., programs or other instructions) and/or data.

In alternative embodiments, secondary memory 1410 may include other similar means for allowing computer software and/or data to be loaded into computer system 1400. Such means can include, for example, a removable storage unit 1422 and an interface 1420. Examples of such can include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

In an embodiment, computer system 1400 includes a frame buffer 1406 and a display 1407. Frame buffer 1406 is in electrical communication with graphics subsystem 1405. Images stored in frame buffer 1406 can be viewed using display 1407. Many of the features of the invention described herein are performed within the graphics subsystem 1405.

Computer system 1400 can also include a communications interface 1424. Communications interface 1424 allows software and data to be transferred between computer system 1400 and external devices via communications path 1426. Examples of communications interface 1424 can include a modem, a network interface (such as Ethernet card), a communications port, a PCMCIA slot and card, etc. Software and data transferred via communications interface 1424 are in the form of signals which can be electronic, electromagnetic, optical or other signals capable of being received by communications interface 1424, via communications path 1426. Note that communications interface 1424 provides a means by which computer system 1400 can interface to a network such as the Internet. Communications path 1426 carries signals 1428 and can be implemented using wire or cable, fiber optics, a phone line, a cellular phone link, an RF link, free-space optics, and/or other communications channels.

Computer system 1400 can include one or more peripheral devices 1432, which are coupled to communications infrastructure 1402 by graphical user-interface 1430. Example peripheral devices 1432, which can form a part of computer system 1400, include, for example, a keyboard, a pointing device (e.g., a mouse), a joy stick, and a game pad. Other peripheral devices 1432, which can form a part of computer system 1400 will be known to a person skilled in the relevant art given the description herein.

In this document, the term “computer program medium” and “computer usable medium” are used to generally refer to media such as removable storage unit 1418, removable storage unit 1422, a hard disk installed in hard disk drive 1412, or a carrier wave or other signal 1428 carrying software over a communication path 1426 to communication interface 1424. These computer program products are means for providing software to computer system 1400.

Computer programs (also called computer control logic or computer readable program code) are stored in main memory 1408 and/or secondary memory 1410. Computer programs can also be received via communications interface 1424. Such computer programs, when executed, enable the computer system 1400 to perform the features of the present invention as discussed herein. In particular, the computer programs, when executed, enable the processor 1404 to perform the features of the present invention. Accordingly, such computer programs represent controllers of the computer system 1400.

In an embodiment where the invention is implemented using software, the software may be stored in a computer program product and loaded into computer system 1400 using removable storage drive 1414, hard drive 1412, interface 1420, or communications interface 1424. Alternatively, the computer program product may be downloaded to computer system 1400 over communications path 1426. The control logic (software), when executed by the one or more processors 1404, causes the processor(s) 1404 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to a person skilled in the relevant art.

In yet another embodiment, the invention is implemented using a combination of both hardware and software.

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of producing a subdivision-based representation of an image, comprising:
accessing one or more control points representing the image;
processing said one or more control points to generate vertices in a floating point texture, said texture including information for subdividing a plurality of faces of the image;
mapping said texture as a vertex array; and
rendering the image from said vertex array.

2. The method according to claim 1, further comprising:
implementing a plurality of rendering passes to simulate subdivision of said plurality of faces.

3. The method according to claim 1, further comprising:
executing one or more fragment programs to generate said vertices in a floating point texture.

4. The method according to claim 1, further comprising:
executing one or more fragment programs to simulate subdivision of said plurality of faces.

5. The method according to claim 1, further comprising:
executing said processing step on a graphics processing unit.

6. A computer program product comprising a computer useable medium having computer readable program code functions embedded in said medium for causing a computer to produce a subdivision-based representation of an image, comprising:
a first computer readable program code function that causes the computer to access one or more control points representing the image;
a second computer readable program code function that causes the computer to process said one or more control points to generate vertices in a floating point texture, wherein said texture includes information for subdividing a plurality of faces of the image;
a third computer readable program code function that causes the computer to map said texture as a vertex array; and
a fourth computer readable program code function that causes the computer to render the image from said vertex array.

7. The computer program product according to claim 8, further comprising:
a fifth computer readable program code function that causes the computer to implement a plurality of rendering passes to simulate subdivision of said plurality of faces.

8. The computer program product according to claim 6, wherein said second computer readable program code function is executed on a graphics processing unit coupled to the computer.
